(19) United States
(12) Patent Application Publication
(10) Pub. No.: US 2018/0007934 A1
(43) Pub. Date: Jan. 11, 2018

(54) Profile Extrusion Process For Producing Shaped Pet Food

(71) Applicant: Qmilk IP GmbH, Hannover (DE)

(72) Inventor: Anke DOMASKE, Hannover (DE)

(21) Appl. No.: 15/201,725

(22) Filed: Jul. 5, 2016

(51) Int. Cl. A23K 40/25; A23K 50/42; A23K 20/158; A23K 20/105; A23K 20/147

(52) U.S. Cl. CPC A23K 40/25; A23K 20/105; A23K 20/147; A23K 20/158; A23K 50/42

(57) ABSTRACT

The invention relates to a profile extrusion process for producing fashioned animal food, especially dog chew bones, the process comprising the following steps:
loading an extruder with casein, a plasticizer and with additives;
preparing a plasticized casein compound containing 10 to 80% casein by weight, wherein the casein and the plasticizer are subject to a mechanical strain at a temperature below 130° C. in the extruder;
molding the casein compound into a profile, wherein the casein compound is pressed through the extruder nozzle onto a transfer device and is consolidated on said transfer device;
curing the profile, wherein the profile is cooled on the transfer device;
portioning the profile into portions of any length, wherein the profile is cut at a corresponding position using a cutting tool.

The present invention relates to a profile extrusion process for the production of fashioned animal food, preferably food for dogs and cats or other domestic animals, especially dietary supplements.

Processes for the production of animal food from proteins are known in prior art.

Document DE 699 31 510 T2 describes that dietary supplements are pre-produced as granulate or pellets and are fashioned for instance into chew bones in an injection molding process in a second step.

Prior art is based on the general assumption that dog food can be processed into dog chew bones by kneading, heating and compacting a powder or granular animal protein such as milk casein or gelatin. Further, as described in JP-PA 51-25 and JP-PA 57-39 616, such a chew bone is produced by rolling such ingredients, cutting them into strips, knotting both ends of each strip and drying in hot air.

From DE 37 24 993 A1 and WO 91/16825 A1 there is also know a chew bone which consists of a kernel that is produced by heating, compacting and molding animal protein such as casein for example, and that is additionally provided with a meat layer that consists of a mixture of meat and fibrous material. This meat layer is wrapped around the kernel and is then dried. The aforementioned processes have in common that animal food that is fashioned in a particular manner can be produced only in batches, i.e. in a discontinuous process. For this reason, the production is relatively complex, maintenance-intensive and inefficient. A continuous process has not been successful so far because of the difficult handling of protein compounds containing a high amount of protein.

On the other hand, the industry has shown great interest in the provision of such a continuous process.

It therefore is an object of the present invention to provide a continuous process for the continuous production of animal food in the form of spatially defined bodies, especially dog chew bones.

This object is achieved by a profile extrusion process for the production of fashioned animal food, especially dog chew bones, the process comprising the following steps:
loading an extruder with casein, a plasticizer and with additives;
preparing a plasticized plasticized casein compound containing 10 to 80% casein by weight, wherein the casein, the plasticizer and the additives are mechanically mixed at a temperature below 130° C. in the extruder;
molding the casein compound into a profile, wherein the casein compound is pressed through a nozzle onto a transfer device and is fixed on the transfer device;
curing the profile, wherein the profile is cooled on the transfer device;
portioning the profile into portions of any length, wherein the profile is cut at a corresponding position using a cutting tool.

The present invention preferably provides animal food/dietary supplements containing high-quality nutritious ingredients in the form of edible and chewable animal food suitable for consumption, the animal food being produced by profile extrusion. Profile extrusion allows the production of chew bones with foamed or solid textures that are extruded in a single step. The casein content in the present invention amounts to 10%-80%.

Due to its water insolubility, casein is difficult to handle during its processing. For this reason it has been extremely difficult so far for the expert to process a compound containing a high amount of casein in an extruder and thereafter molding this compound. Until now, many casein formulations are added with soy protein moieties or with starch in order to make them suitable for extrusion. Known animal food containing a high amount of milk protein still has to be shaped by hand because due to the particularly difficult texturing of the milk protein moiety there has been no success to date in producing such animal food using modern technologies. Up to now, such formulations could not be produced in an extruder because the right setting of the parameters of the extruder for obtaining good mixing and shear effects, in combination with the suitable nozzle has not yet been found.

The texture and the viscosity of the fashioned chewable material can be adjusted via the formulation and/or the molding process. Accordingly, it is possible to contribute in a favorable manner to the material being gnawn to pieces by a pet and to react to the state of the dental apparatus, depending on the consistency of the material. A soft or flexible texture of the material stimulates salivation, whereas a solid and rigid texture makes it difficult for the pet to gnaw the material away so that the pet is kept busy for a longer time and its teeth are mechanically cleaned in addition.

The invention is based on the knowledge that milk proteins and especially casein and their derivatives can be plasticized and thus polymerized. Preferably, it is provided that plasticizing is effected at temperatures up to 130° C.

For an even more gentle treatment, the protein is thoroughly mixed or kneaded together with a plasticizer and is thus subject to mechanical strain. The plasticizer significantly reduces the required plastification temperature.

The milk protein is casein.

The protein that is produced from milk can be obtained by the separation of milk. To this end and according to a first procedure, the milk mixed with rennet, other suitable enzymes or acid can be directly fed to the process as a flocculated mixture, or the pressed flocculated protein can be used in a moist condition. According to a further possible procedure, a pure or mixed protein previously obtained in a separate step and processed, if necessary, i.e. a protein fraction of milk, can be used for instance in a dried condition as a powder. The casein compound can be mixed with animal or vegetable proteins. Soy and gluten or gelatin are then added to the process and are worked in.

For modifying the compound, additives are added to it.

The additives can give the product new properties such as taste, effectivenes texture, haptic, scent, appearance, form, weight or color.

For modifying the taste, natural additives such as meat or fish-like substances, natural or artificial flavors, fruit, vegetable, root, seeds or grains are admixed. Waste products of the meat and fish industry are preferably used, for example offal, bones, cartilage, broth, but also fresh meat. Beachwood smoke or similar substances are used in a concentrated form, which give the product the meaty taste loved by dogs.

For the fruity taste there may be added local and international kinds of fruits and vegetables such as apple, carrot, potato, mango, pineapple. Even locust bean gives the product a fruity taste and even spices such as garlic, onion, brewer's yeast or pepper can be added.

To enhance or supplement effectiveness, additives such as vitamins, minerals, dietary fiber, herbs, carbon hydrates, trace elements, fats and oils may be added. These may include for example chloroform, calcium, magnesium, phosphorus vitamin B, vitamin C or iron. Coconut oil, rendered butter, lard, lipids, saturated or unsaturated fatty adds are preferably used as fats. The same additionally serve as a processing aid of the casein compound in the process. Oils like sunflower oil, rapeseed oil, safflower oils or Argan oil are preferably used as processing auxiliaries. Rize, maize, potato, tapioca or wheat are preferably used as carbon hydrates.

For adjusting the weight of the products, mineral or biological fillers such as calcium carbonate, wood flour, walnut shells or cellulose are used.

To avoid that the product instantly crushes when it is chewed, natural or synthetic fibers are added. These fibers can consist of protein, cellulose or a synthetic substance.

As the optical appearance plays an important part in purchasing the products, the product can be sprayed or sprinkled from outside. Natural or synthetic coloring agents as well as fibers or particles are normally used for this purpose. But also flavoring agents can be subsequently applied and thus generate much higher acceptance.

In a preferred embodiment, plasticizing is effected with the aid of a co-rotating or counter-rotating twin-screw extruder. The selected ingredients are fed to the extruder at various injection points along the screw either in the form of a pre-mixture or are fed to the process as individual raw materials or substance mixtures.

In a preferred embodiment it is provided that the casein is fed as a dry powder through a funnel at the entrance of the extruder, whereas the plasticizer and the other additives are fed to the process at a later time. The plasticizer is preferably water that is added in an amount of between 10 and 80% by weight of the protein, preferably in an amount of approx 10 to 50% by weight of the protein content. Instead of water or admixed to it, other plasticizers can be used, for example alcohols, polyalcohols, carbon hydrates in aqueous solution and particularly aqueous polysaccharide solutions.

The casein compound is plasticized and compacted in the extruder at a temperature below 130° C. Depending on the moisture content of the melt, a degasification can provided at the end of the process. The same removes moisture and air from the melt.

At the exit of the extruder the melt is pressed through a nozzle, whereby bodies having the cross section of the nozzle opening are produced with an endless length. The specially developed screw with an adapted nozzle guarantees the continuous pronounced form of the extrudate. The protein compound can be delivered in the form of one or several uniform profiles.

The molded profile is continuously removed from the nozzle by means of a transfer device. Preferably, said transfer device is constructed as a water or air-cooled conveyor belt. The cross-sectional shape of the profile is consolidated as a result of cooling. After its consolidation, the profile is cut to the desired length using a cutting device. The challenge in profile extrusion is maintaining the shape of the extruded material until it has cooled. Otherwise the extruded material would collapse and deform. A withdrawal device downstream of the extruder Provides for a constant and continuous removal.

Due to the plasticization, the process offers the benefits of melt extrusion. In the thermoplastic extrusion, the materials are however converted into a plastic condition by heating and are deformed in this manner. The temperature in this case must exceed the glass transition temperature of the protein so that the latter changes from the amorphous into the rubber-like plastic state. The plasticization according to the invention requires comparatively low temperatures and thus enables energy savings compared to melt extrusion. Defined temperature levels are preferably set in the different extruder zones which enable optimum plasticization.

The casein compound can be foamed in the extruder also physically and/or chemically. For this purpose, a foaming agent is added to the process. This foaming agent can be gaseous such as oxygen or nitrogen for example, but also other gases or solid foaming agents such as sodium hydrogen carbonate can be fed to the extruder. The same is homogeneously distributed in the melt via a mixing zone so that uniform foaming is achieved at the nozzle end. This has not been possible for the expert so far. Foaming has previously been possible only by microwave irradiation in a batch process.

The casein compound is pressed through a nozzle, whereby the compound is molded. It is also possible to combine several material streams of different protein compounds in the nozzle and to deliver them jointly. In this case, the compounds are each pre-mixed in a separate extruder and are delivered from a common nozzle so that one product consists of different compounds.

The formulation according to the invention also has a high nutritional value and excellent digestibility. The biological quality of the animal protein that is used is also very high.

The addition of further substances is not excluded. There may be specifically added buckwheat or rice, and even fibers or fruits may be added to the protein compound for example.

The advantages achieved with the invention are among others that in the production of the inventive animal food from casein, molding of the compound is possible in a continuous process so that a batch process can be dispensed with.

### EMBODIMENT 1

Preparation of a casein-polymer compound. Extrusion takes place in a 30 mm diameter twin-screw extruder type 30 E from Dr. Collin. The extruder comprises at least 4 cylinders. The flange with the nozzle is disposed on the end of the extruder. Depending on the addition of further substances, the extruder may be expanded up to 12 cylinders. Additives can thus be fed to the process successively, whereby the protein compound is given various properties. The strand or strands are subsequently cooled and their shapes consolidated. Thereafter, the strands are cut into pieces of equal length. The finished products directly fall out from the cutting device. Depending on the variant the products can be refined using a reshaping process or surface treatment.

Heating takes place via 4 cylinder heating zones with the following temperature characteristic.

| | Temperature | | | | | |
|---|---|---|---|---|---|---|
| | 65 | 70 | 75 | 80 | 85 | 60 |
| Function | Material | Water | Plasticization | Delivery | Flange | Nozzle |
| | feed | feed | zone | zone | | |
| Heating | I | II | II | II | III | IV |
| zone | | | | | | |

The casein is added via a dosing device. Water is added by means of a pump. The additives, especially rice flour, are added via additional dosing devices. The casein compound is processed into animal food in a single step by means of an extrusion process.

Depending on the desired texture of the finished product, the casein compound may be subject to modifications during plasticization in the plasticization zone. If a soft and particularly a spongy texture of the product is desired, it is provided for the casein compound being foamed by means of physical and/or chemical measures. The foamed casein compound can then be extruded in a corresponding manner through the nozzle and can be consolidated on the conveyor belt so that the resulting profile is given the desired texture after consolidation.

The production process and the processing of the casein compound into animal food is illustrated in FIG. 1. The raw materials fed to the extruder 3 via a dosing device 1 and the plasticizer added by means of a pump 2 are kneaded to form a casein mixture. The casein mixture is then molded and delivered through the nozzle 4. The transfer device 5 transfers and consolidates the profile. The cutting device cuts pieces of equal length.

1. Profile extrusion process for producing fashioned animal food, especially dog food, the process comprising the steps:
loading an extruder with casein, a plasticizer aid with additives;
preparing a plasticized casein compound containing 10 to 80% casein by weight, wherein the casein, the plasticizer and the additives are mechanically mixed in the extruder at a temperature below 130° C.;
molding said casein compound into a profile by means of constant delivery through the extruder nozzle;
uniformly discharging the profile and consolidation of its shape through cooling, by means of the transfer device;
continuously portioning he profile into pieces of equal length using a cutting device.

2. Profile extrusion process according to claim 1, wherein the casein compound is foamed in the extruder nozzle using physical and/or chemical foaming agents.

3. Profile extrusion process according to claim 1, wherein the casein compound is formed into one or several profiles through the extruder nozzle.

4. Profile extrusion process according to claim 1, wherein the casein compound in the extruder is added at least one vegetable protein in amount of 5 to 50% by weight of the total mass, said vegetable protein being contained in nuts, kernels or fruits.

5. Profile extrusion process according to claim 1, wherein the casein compound is mixed with protein from fish or meat.

6. Profile extrusion process according to claim 1, wherein the casein compound in the extruder is added with saturated or unsaturated fatty acids.

7. Profile extrusion process according to claim 1, wherein the casein compound in the extruder is added with carbon hydrates.

8. Profile extrusion process according to claim 1, wherein the casein compound in the extruder is mixed with at least one additive selected from the group consisting of natural flavoring substances, artificial flavoring substances, herbs, fruits, mineral substances, vitamins, polysaccharides or chlorophyll.

9. Profile extrusion process according to claim 1, wherein an alditol, especially sorbitol, is used as a plasticizer.

10. Profile extrusion process according to claim 1, wherein the casein compound in the extruder is mixed with particles, natural fibers, synthetic fibers and/or granulate.

11. Profile extrusion process according to claim 1, wherein the profile is sprinkled with particles, natural fibers, synthetic fibers and/or granulate.

12. Profile extrusion process according to claim 1, wherein the casein compound is fed to the extruder nozzle from a plurality of spatially separated material streams.

13. Profile extrusion process according to claim 1, wherein the casein compound is moved through several successively positioned extruders.

14. Profile extrusion process according to claim 1, wherein the profile is sprayed with liquid immediately after leaving the nozzle.

15. Profile extrusion process according to claim 1, wherein the profile is molded in a press before or after portioning.
